(19) United States
(12) Patent Application Publication
(10) Pub. No.: US 2026/0225204 A1
(43) Pub. Date: Aug. 6, 2026

(54) HANDHELD GRINDER AND METHOD FOR CONTROLLING ILLUMINATOR FOR HANDHELD GRINDER

(71) Applicant: MAKITA CORPORATION, Anjo-shi (JP)

(72) Inventors: Hiroki KANEKO, Anjo-shi (JP); Toshiya Kutsuna, Anjo-shi (JP); Yuya Matsuyama, Anjo-shi (JP)

(73) Assignee: MAKITA CORPORATION, Anjo-shi (JP)

(21) Appl. No.: 19/456,222

(22) Filed: Jan. 22, 2026

(30) Foreign Application Priority Data
Jan. 29, 2025 (JP) 2025-013094

(51) Int. Cl. B24B 23/00; B24B 23/02; B24B 47/12

(52) U.S. Cl. CPC B24B 23/005; B24B 23/022; B24B 47/12

(57) ABSTRACT

One aspect of the present disclosure provides a handheld grinder including a housing, a power port, a motor, a chuck, an illuminator, a first manual operating device, and a control circuit. The housing extends along a first direction. The first manual operating device is arranged in a region of the housing between the motor and the power port along the first direction. The first manual operating device receives a first manual operation. The control circuit sets an operation mode of the illuminator to either a light-on mode or a light-off mode in response to the first manual operation.

### CROSS-REFERENCE TO RELATED APPLICATIONS

The present application claims the benefit of Japanese Patent Application No. 2025-013094 filed on January 29, 2025, with the Japan Patent Office, the entire disclosure of which is incorporated herein by reference.

### BACKGROUND

The present disclosure relates to a handheld grinder.

WO 2017/097873 (A1) discloses a rotary power tool including a housing, a tool holder, and a lighting system. The tool holder and the lighting system are arranged at a front end of the housing. The housing includes a grip located rearward of the lighting system. The housing houses a motor inside the grip. The lighting system includes a light source and a switch. The switch is operated to turn the lighting system on and off.

### SUMMARY

In the rotary tool, the lighting system is arranged frontward of the grip and the motor, and is positioned in the immediate vicinity of the tool holder. That is, the light source and the switch are arranged in the vicinity of the tool holder. This configuration may lead to a deterioration in workability. Specifically, the operator's field of view may be obstructed by the switch, making it difficult to see a tool attached to the tool holder. Furthermore, the front end portion of the rotary power tool may be enlarged, thereby possibly reducing workability in confined spaces.

It is desirable that one aspect of the present disclosure can provide a handheld grinder capable of causing an illuminator to emit light and/or cease emitting light while reducing or avoiding deterioration in workability.

In the present disclosure, terms such as “first,” “second,” etc. are intended only to distinguish elements from one another and are not intended to limit the order or number of the elements. Therefore, a first element may be referred to as a second element, and similarly, the second element may be referred to as the first element. In addition, it is acceptable to include the first element without the second element, and similarly, it is acceptable to include the second element without the first element.

One aspect of the present disclosure provides a handheld grinder including a housing, a power port, a motor, a chuck, an illuminator, a first manual operating device, and a control circuit.

The housing extends along a first direction. The housing includes an outer surface and a grip. The grip is gripped by a user of the handheld grinder.

The power port is arranged on the outer surface of the housing. The power port is configured to receive an electric power from a power source.

The motor is housed in the housing. The motor is spaced apart from the power port in the first direction. The motor is driven by the electric power received by the power port.

The chuck is spaced apart from the motor in the first direction. The chuck is configured to detachably attach a machining tool. The machining tool grinds and/or polishes a workpiece. The machining tool includes a support shaft. The support shaft has a rod shape. The support shaft is detachably attached to the chuck. The chuck is rotated by the motor. The support shaft may be detachably fixed to the machining tool.

The illuminator emits light onto the machining tool and/or the workpiece in contact with the machining tool.

The first manual operating device is arranged in a region of the housing between the motor and the power port along the first direction. The region may include, but does not necessarily include, a region where the motor is arranged and/or a region where the power port is arranged. The first manual operating device receives a first manual operation. The first manual operation is an operation performed to selectively set an operation mode of the illuminator to either a light-on mode or a light-off mode.

The control circuit sets the operation mode to either the light-on mode or the light-off mode in response to the first manual operation. The control circuit controls the illuminator not to emit the light based on the operation mode being set to the light-off mode. The control circuit controls the illuminator to emit the light based on the operation mode being set to the light-on mode.

In the handheld grinder configured in this manner, the first manual operating device is arranged between the motor and the power port. Thus, it is possible to reduce or avoid deterioration in workability. Specifically, it is possible to reduce or avoid obstruction of the user's field of view due to the first manual operating device during operation of the machining tool. That is, it is possible to reduce or avoid a blind spot of the machining tool and/or the workpiece caused by the first manual operating device. Alternatively or additionally, the front end portion of the handheld grinder is less enlarged, thereby reducing or avoiding deterioration in workability in confined spaces.

Another aspect of the present disclosure provides a method for controlling an illuminator for a handheld grinder. The handheld grinder includes a motor; a power port configured to receive an electric power for driving the motor; a chuck configured to detachably attach a machining tool capable of grinding and/or polishing a workpiece and configured to be driven by the motor; and the illuminator configured to emit light onto the machining tool.

The method includes:

arranging a manual operating device between the motor and the power port of the handheld grinder, the manual operating device being configured to receive a manual operation for setting an operation mode of the illuminator to either a light-on mode in which the illuminator emits light or a light-off mode in which the illuminator does not emit light; and

setting the operation mode in response to the manual operation received by the manual operating device.

In this method, the manual operating device is arranged at a position (or in a region) between the motor and the power port. Consequently, it is possible to reduce or avoid deterioration in workability.

### BRIEF DESCRIPTION OF THE DRAWINGS

An example embodiment of the present disclosure will be described hereinafter by way of example with reference to the accompanying drawings, in which:

FIG. 1 is a perspective view of a handheld grinder in one embodiment;

FIG. 2 is a cross-sectional view of the handheld grinder;

FIG. 3 is a partial top view of the handheld grinder;

FIG. 4 is a perspective view showing a second manual operating device and its surrounding structure;

FIG. 5 is a perspective view of a front end portion of the handheld grinder;

FIG. 6 is a circuit diagram showing an electrical configuration of the handheld grinder;

FIG. 7 is a flowchart showing a part of a main process; and

FIG. 8 is a flowchart showing another part of the main process.

### DETAILED DESCRIPTION OF EXEMPLARY EMBODIMENTS

### Overview of Embodiments

One embodiment may provide a handheld grinder including at least any one of the following features.

Feature 1: a housing.

Feature 2: the housing extends along a first direction (or a specified extending direction).

Feature 3: the housing includes an outer surface (or a side surface).

Feature 4: the housing includes a grip. The grip is configured to be gripped by a user of the handheld grinder.

Feature 5: a power port configured to receive an electric power from a power source.

Feature 6: the power port is arranged on the outer surface of the housing.

Feature 7: a motor.

Feature 8: the motor is housed in the housing and spaced apart from the power port in the first direction.

Feature 9: the motor is configured to be driven by the electric power received by the power port.

Feature 10: a chuck configured to detachably attach a machining tool. The machining tool may have a support shaft. The support shaft may have a rod shape. The chuck may be configured to detachably attach the support shaft.

Feature 11: the chuck is spaced apart from the motor in the first direction.

Feature 12: the chuck is configured to detachably attach the support shaft of the machining tool. The support shaft may be detachably or non-detachably fixed to the machining tool.

Feature 13: the machining tool is configured to grind and/or polish a workpiece (or work material).

Feature 14: the chuck is configured to be rotated by the motor.

Feature 15: an illuminator (or an illumination device, or a lighting device).

Feature 16: the illuminator is configured to emit light onto (or for illuminating) the machining tool and/or the workpiece in contact with the machining tool.

Feature 17: a first manual operating device.

Feature 18: the first manual operating device is arranged in a specified region (or an operating device arrangement region) of the housing. The specified region is a region between the motor and the power port along the first direction.

Feature 19: the first manual operating device is configured to receive a first manual operation. The first manual operation may be performed by the user of the handheld grinder.

Feature 20: the first manual operation is an operation performed to selectively set an operation mode of the illuminator to either a light-on mode or a light-off mode. The light-on mode may be defined as a mode in which the illuminator emits the light (i.e., the illuminator is turned on). The light-off mode may be defined as a mode in which the illuminator does not emit the light (i.e., the illuminator is turned off).

Feature 21: a control circuit.

Feature 22: the control circuit is configured to set the operation mode to either the light-on mode or the light-off mode in response to the first manual operation.

Feature 23: the control circuit is configured to control the illuminator not to emit the light based on the operation mode being set to the light-off mode. Additionally, or alternatively, the control circuit is configured to control the illuminator to emit the light based on the operation mode being set to the light-on mode.

In the handheld grinder including at least the features 1 to 23, the first manual operating device is arranged in the specified region. Therefore, it is possible to cause the illuminator to emit light and/or cease emitting light while reducing or avoiding deterioration in workability. Specifically, it is possible to reduce or avoid obstruction of the user's field of view due to the first manual operating device. That is, it is possible to reduce or avoid a blind spot of the machining tool and/or the workpiece caused by the first manual operating device. Alternatively, or additionally, the front-end portion of the handheld grinder is less enlarged, thereby reducing or avoiding deterioration in workability in confined spaces.

In one embodiment, the handheld grinder may include a first circuit. The first circuit may be configured to output a first signal corresponding to the first manual operation. The control circuit may be configured to (i) receive the first signal and (ii) set the operation mode based on the received first signal. Setting the operation mode may mean setting the operation mode to the light-on mode or the light-off mode. In one embodiment, the handheld grinder may include a first input device. The first input device may include a first manual operating device and the first circuit.

In one embodiment, the handheld grinder may include a transmission device (or transmission section). The transmission device may be configured to transmit rotational force from the motor to the chuck to thereby rotate the chuck. The transmission device may include a spindle at its front end portion. The rotational force of the motor may be transmitted to the spindle. The chuck may be arranged at a front end of the spindle. The chuck may rotate together with the spindle in response to the motor rotating.

Examples of the motor include a brushed DC motor, a brushless motor (including a brushless DC motor and/or a brushless AC motor), an AC motor, and a stepping motor.

Examples of the chuck include a collet chuck, a drill chuck, a scroll chuck, a cam lock chuck, an independent chuck, and an electromagnetic chuck.

Examples of the machining tool include grinding wheels. Examples of the grinding wheels include natural grinding wheels and artificial grinding wheels. Examples of the workpiece include metals (e.g., general steel materials, hardened steel, special steel), concrete, wood materials, and resin materials.

Examples of the power source include a battery and a commercial AC power source. Examples of the power port include a battery port and an outlet section of a power cord. The battery port is configured to detachably attach the battery. The power cord supplies AC power from a commercial AC power source into the handheld grinder.

Examples of the first manual operating device include rotary members, sliders, buttons, keys, levers, triggers, paddles, toggles, and touch switches (or touch panels). Examples of the rotary members include knobs, dials, rotors, spindles, and handles.

The “first manual operating device” may alternatively be referred to as a “first input interface,” a “first user interface,” a “first manual switch,” a “first switch,” or a “first manual controller,” for example.

The specified region may be defined based on a first region and a second region. The first region is a region that extends along the first direction and in which the motor is present. The second region is a region that extends along the first direction and in which the power port is present. The specified region may be defined as a region between a first end surface and a second end surface. The first end surface (i) may pass through any first point within the first region and (ii) may be perpendicular to the first direction. The second end surface (i) may pass through any second point within the second region and (ii) may be perpendicular to the first direction. The first point may be located at an extreme end of the first region in the first direction. The first point may be located at an extreme end of the first region on a side opposite to the first direction. The second point may be located at an extreme end of the second region in the first direction. The second point may be located at an extreme end of the second region on the side opposite to the first direction. The second point may be located at an extreme end of the housing (or the handheld grinder) on the side opposite to the first direction.

The housing may extend in a linear manner. Alternatively, the housing may extend in a non-linear manner. For example, the housing may be partially bent along the first direction.

The first manual operating device may be completely included in the specified region or partially included in the specified region.

The illuminator may include any light source capable of emitting light. Examples of the light source include LEDs. The illuminator may be arranged at any position. For example, the illuminator may be arranged at an end of the housing in the first direction. The illuminator may be arranged such that at least a portion of the light from the illuminator reaches the machining tool and/or the workpiece in a straight path without reflection or diffraction.

One embodiment may include at least any one of the following features in addition to or in place of at least any one of the features 1 to 23.

Feature 24: the first manual operating device is configured to receive a second manual operation different from the first manual operation.

Feature 25: the control circuit is configured to perform a specified function based on the second manual operation having been performed on the first manual operating device.

Feature 26: the specified function is different from setting the operation mode.

In the handheld grinder including at least the features 1 to 26, the first manual operating device is used for setting the operation mode and for performing the specified function. Therefore, it is possible to suppress an increase in cost and/or size of the handheld grinder.

One embodiment may include at least any one of the following features in addition to or in place of at least any one of the features 1 to 26.

Feature 27: the specified function includes setting a desired rotational speed for the motor in response to the second manual operation.

Feature 28: the control circuit is configured to control the motor such that the motor rotates at the desired rotational speed that has been set.

In the handheld grinder including at least the features 1 to 28, the operation mode and the desired rotational speed can be set using the first manual operating device.

One embodiment may include the following feature in addition to or in place of at least any one of the features 1 to 28.

Feature 29: the first manual operating device is configured to be manually rotated.

In the handheld grinder including at least the features 1 to 23, and 29, the first manual operation and the second manual operation can be performed easily and efficiently. In other words, various forms of the first manual operation and the second manual operation can be adopted.

The first manual operating device may be configured to be rotated continuously through 360 degrees or more. The first manual operating device may be configured so as not to be rotated more than 360 degrees in the same rotational direction. That is, a rotational range of the first manual operating device may be limited to less than 360 degrees.

In one embodiment, the first manual operating device may be in the form of, for example, a dial, a knob, a rotor, a spindle, or a handle. That is, the first manual operation may include rotating the first manual operating device. The first circuit may be configured to output a first signal corresponding to a rotational position of the first manual operating device. The first signal may vary continuously or stepwise according to the rotational position of the first manual operating device. That is, the first input device may be, for example, in the form of a potentiometer. Alternatively, the first circuit may be configured to output one of two or more first signals respectively corresponding to the two or more speed setting positions. That is, the first input device may be, for example, in the form of a rotary switch.

One embodiment may include the following features in addition to or in place of at least any one of the features 1 to 29.

Feature 30: the first manual operation includes (i) rotating the first manual operating device by a specified amount of rotation or more, and (ii) subsequently reversely rotating the first manual operating device by the specified amount of rotation or more.

In the handheld grinder including at least the features 1 to 23, 29, and 30, the first manual operation includes an operation that is not normally performed or that is less likely to be performed. Therefore, it is possible to reduce or avoid unintentional execution of the first manual operation. The specified amount of rotation may be less than 360 degrees or equal to or greater than 360 degrees. A starting position for the first manual operation may be predetermined.

One embodiment may include at least any one of the following features in addition to or in place of at least any one of the features 1 to 30.

Feature 31: the first manual operating device includes two or more speed setting positions (or two or more speed setting ranges; the same applies hereinafter).

Feature 32: the two or more speed setting positions are arranged to be spaced apart from each other along a rotational direction of the first manual operating device.

Feature 33: the two or more speed setting positions are arranged such that they respectively correspond to two or more desired rotational speeds (or candidates) different from each other in ascending order or descending order along the rotational direction of the first manual operating device. In other words, the two or more desired rotational speeds correspond to the two or more speed setting positions in ascending order or descending order.

Feature 34: the second manual operation includes aligning any one speed setting position of the two or more speed setting positions with a reference position.

Feature 35: the control circuit is configured to control the motor such that the motor rotates at one desired rotational speed of the two or more desired rotational speeds, the one desired rotational speed corresponding to the one speed setting position aligned with the reference position.

In the handheld grinder including at least the features 1 to 29 and 31 to 35, it is possible to easily set not only the operation mode but also the desired rotational speed using the first manual operating device.

One embodiment may include at least any one of the following features in addition to or in place of at least any one of the features 1 to 35.

Feature 36: the first manual operation includes (i) rotating the first manual operating device from a first position to a second position, and (ii) subsequently rotating the first manual operating device from the second position to the first position.

Feature 37: the first position corresponds to a state in which a minimum speed position is aligned with the reference position, the minimum speed position being one of the two or more speed setting positions corresponding to a lowest desired rotational speed (or its candidate) among the two or more desired rotational speeds. That is, when the first manual operating device is rotated to the first position, the speed setting position of the first manual operating device corresponding to the lowest desired rotational speed is aligned with the reference position.

Feature 38: the second position corresponds to a state in which a maximum speed position is aligned with the reference position, the maximum speed position being one of the two or more speed setting positions corresponding to a highest desired rotational speed (or its candidate) among the two or more desired rotational speeds. That is, when the first manual operating device is rotated to the second position, the speed setting position of the first manual operating device corresponding to the highest desired rotational speed is aligned with the reference position.

In the handheld grinder including at least the features 1 to 29 and 31 to 38, the first manual operation includes an operation that is not normally performed or that is less likely to be performed at the time of setting the desired rotational speed. Therefore, it is possible to reduce or avoid unintentional execution of the first manual operation at the time of setting the desired rotational speed.

One embodiment may include the following features in addition to or in place of at least any one of the features 1 to 38.

Feature 39: the first manual operation includes (i) rotating the first manual operating device from the second position to the first position, and (ii) subsequently rotating the first manual operating device from the first position to the second position.

In the handheld grinder including at least the features 1 to 29, 31 to 35, and 37 to 39, the first manual operation includes an operation that is not normally performed or that is less likely to be performed at the time of setting the desired rotational speed. Therefore, it is possible to reduce or avoid unintentional execution of the first manual operation at the time of setting the desired rotational speed.

One embodiment may include at least any one of the following features in addition to or in place of at least any one of the features 1 to 39.

Feature 40: the control circuit is configured to switch the operation mode based on the first manual operating device having received the first manual operation during a period between activation of the control circuit and expiration of a switchable period. The switchable period may be preset.

Feature 41: the control circuit is configured not to switch the operation mode based on (i) the switchable period has elapsed since the activation of the control circuit and (ii) the first manual operating device having received the first manual operation.

In the handheld grinder including at least the features 1 to 23, 40, and 41, the period during which the operation mode can be switched is limited. Therefore, unintentional operation of the first manual operating device is reduced or avoided.

One embodiment may include at least any one of the following features in addition to or in place of at least any one of the features 1 to 41.

Feature 42: the switchable period starts upon the activation of the control circuit.

Feature 43: the switchable period is from the activation of the control circuit to expiration of a first time period.

In the handheld grinder including at least the features 1 to 23, 40 to 43, an appropriate (e.g., necessary and sufficient) switchable period can be set.

One embodiment may include at least any one of the following features in addition to or in place of at least any one of the features 1 to 43.

Feature 44: a second manual operating device that is distinct from the first manual operating device.

Feature 45: the second manual operating device is configured to receive a third manual operation. The third manual operation instructs the control circuit to drive the motor.

Feature 46: the switchable period ends based on the second manual operating device having received the third manual operation.

In the handheld grinder including at least the features 1 to 23, 40, 41, and 44 to 46, an appropriate (e.g., necessary and sufficient) switchable period can be set.

Examples of the second manual operating device include sliders, triggers, paddles, levers, buttons, keys, toggles, touch switches (or touch panels), and the aforementioned rotary members.

In one embodiment, the handheld grinder may include a second circuit. The second circuit may be configured to output a second signal corresponding to a third manual operation performed on the second manual operating device. The control circuit may be configured to (i) receive the second signal and (ii) detect (or determine) that the third manual operation has been performed on the second manual operating device based on the received second signal. In one embodiment, the handheld grinder may include a second input device. The second input device may include the second manual operating device and the second circuit.

The term "second manual operating device" may alternatively be referred to as a "second input interface," a "second user interface," a "second manual controller," or a "second manual switch", for example.

One embodiment may include the following features in addition to or in place of at least any one of the features 1 to 46.

Feature 47: the control circuit is configured to control the illuminator to emit the light (or to turn on the illuminator) according to a first lighting pattern based on the operation mode having been switched from the light-off mode to the light-on mode.

In the handheld grinder including at least the features 1 to 23, and 47, the user can easily recognize that the operation mode has been switched to the light-on mode.

One embodiment may include at least any one of the following features in addition to or in place of at least any one of the features 1 to 47.

Feature 48: the control circuit is configured to control the illuminator (i) to emit the light according to a second lighting pattern or (ii) not to emit the light, based on the operation mode having been switched from the light-on mode to the light-off mode.

Feature 49: the second lighting pattern is different from the first lighting pattern.

In the handheld grinder including at least the features 1 to 23, and 47 to 49, the user can easily recognize that the operation mode has been switched to the light-off mode.

One embodiment may include at least any one of the following features in addition to or in place of at least any one of the features 1 to 49.

Feature 50: a memory (or a storage).

Feature 51: the control circuit is configured to store, in the memory, the operation mode that has been currently set. In other words, the control circuit is configured to store the set operation mode in the memory based on the operation mode having been set to the light-on mode or the light-off mode in response to the first manual operation.

In the handheld grinder including at least the features 1 to 23, 50, and 51, it is possible to effectively utilize the operation mode stored in the memory. For example, the operation mode can be set to the stored operation mode under specific conditions. Examples of the memory include, but are not limited to, electrically rewritable non-volatile memories.

One embodiment may include the following features in addition to or in place of at least any one of the features 1 to 51.

Feature 52: the control circuit is configured to set the operation mode to the operation mode stored in the memory (i.e., either the light-on mode or the light-off mode stored in the memory) in response to activation of the control circuit.

In the handheld grinder including at least the features 1 to 23, 50 to 52, it is possible to easily maintain the most recently set operation mode.

One embodiment may include at least any one of the following features in addition to or in place of at least any one of the features 1 to 52.

Feature 53: the control circuit is configured to detect an anomaly of the handheld grinder.

Feature 54: the control circuit is configured to control (or turn on or activate) the illuminator to emit the light according to a third lighting pattern based on the anomaly having been detected. The control circuit may control the illuminator to emit the light according to the third lighting pattern regardless of which operation mode is set when the anomaly has been detected.

In the handheld grinder including at least the features 1 to 23, 53, and 54, the user can easily and efficiently recognize the occurrence of an anomaly via the illuminator.

One embodiment may include at least any one of the following features in addition to or in place of at least any one of the features 1 to 54.

Feature 55: the control circuit is configured to control the illuminator to emit the light based on (i) the operation mode being set to the light-on mode and (ii) a lighting requirement having been satisfied or being satisfied.

Feature 56: the control circuit is configured to control the illuminator not to emit the light based on (i) the operation mode being set to the light-off mode and (ii) the lighting requirement having been satisfied or being satisfied.

In the handheld grinder including at least the features 1 to 23, 55, and 56, it is possible to easily perform work while keeping the illuminator on or off using the first manual operation.

One embodiment may include the following features in addition to or in place of at least any one of the features 1 to 56.

Feature 57: the lighting requirement is satisfied based on the second manual operating device having received the third manual operation.

In the handheld grinder including at least the features 1 to 23, 44, 45 and 55 to 57, it is possible to process the workpiece using the machining tool while keeping the illuminator on.

One embodiment may include the following features in addition to or in place of at least any one of the features 1 to 57.

Feature 58: the lighting requirement is satisfied based on an elapsed time since activation of the control circuit not exceeding a second time period.

In the handheld grinder including at least the features 1 to 23, 55, 56, and 58, the user can recognize the set operation mode when the control circuit is activated.

One embodiment may include at least any one of the following features in addition to or in place of at least any one of the features 1 to 58.

Feature 59: the power source includes a battery.

Feature 60: the power port includes a battery port configured to detachably attach the battery.

In the handheld grinder including at least the features 1 to 23, 59, and 60, the first manual operating device is arranged closer to the battery port than to the chuck. Therefore, the user can quickly perform the first manual operation after attaching the battery to the battery port.

One embodiment may include at least any one of the following features in addition to or in place of at least any one of the features 1 to 60.

Feature 61: the battery port is configured such that the battery is attached based on the battery being moved in a second direction (or a specified attachment direction) relative to the battery port.

Feature 62: the outer surface of the housing includes a surface region facing toward a third direction (i.e., a surface portion or a surface facing toward the attachment direction).

Feature 63: the first manual operating device is arranged on the surface region.

In the handheld grinder including at least the features 1 to 23, and 59 to 63, the user can quickly perform the first manual operation after attaching the battery to the battery port.

The surface region may include an opening. The first manual operating device may be arranged in the opening. The first manual operating device may be arranged so as to extend from the opening to the exterior of the handheld grinder (i.e., in the third direction).

One embodiment may provide a method for controlling an illuminator for a handheld grinder. The method includes at least any one of the following features.

Feature 64: arranging a manual operating device between a motor and a power port of the handheld grinder. The battery port may be configured to receive an electric power for driving the motor. The motor may be configured to drive a chuck. The chuck may be configured to detachably attach a machining tool. The machining tool may include a support shaft having a rod shape, the support shaft being fixed to the machining tool. The chuck may be configured to detachably attach the support shaft. The machining tool may be configured to grind and/or polish a workpiece. The handheld grinder may include the illuminator. The illuminator may be configured to emit light onto the machining tool. The manual operating device may be configured to receive a manual operation. The manual operation may be performed to selectively set an operation mode of the illuminator to either a light-on mode or a light-off mode. The light-on mode may be a mode in which the illuminator emits light. The light-off mode may be a mode in which the illuminator does not emit the light.

Feature 65: setting the operation mode in response to the manual operation received by the manual operating device.

According to the method including at least features 64 and 65, it is possible to cause the illuminator to emit light and/or cease emitting light while reducing or avoiding deterioration in workability. Specifically, it is possible to reduce or avoid obstruction of the user's field of view due to the manual operating device. Alternatively or additionally, the front end portion of the handheld grinder is less enlarged, thereby reducing or avoiding deterioration in workability in confined spaces.

The method may further include: emitting the light from the illuminator based on the operation mode being set to the light-on mode; and/or not emitting the light from the illuminator based on the operation mode being set to the light-off mode.

In one embodiment, the control circuit may be integrated into a single electronic unit, a single electronic device, or a single circuit board.

In one embodiment, the control circuit may be a combination of two or more electronic circuits, two or more electronic units, or two or more electronic devices separately provided on or in the handheld grinder.

In one embodiment, the control circuit may include a microcomputer (or a microcontroller or a microprocessor), a wired logic, an Application Specific Integrated Circuit (ASIC), an Application Specific Standard Product (ASSP), a programmable logic device (such as a field programmable gate array (FPGA)), a discrete electronic component, and/or combinations thereof.

In one embodiment, the features 1 through 65 may be combined in any combinations. In one embodiment, any of the features 1 through 65 may be excluded.

### 2. Specific Embodiment

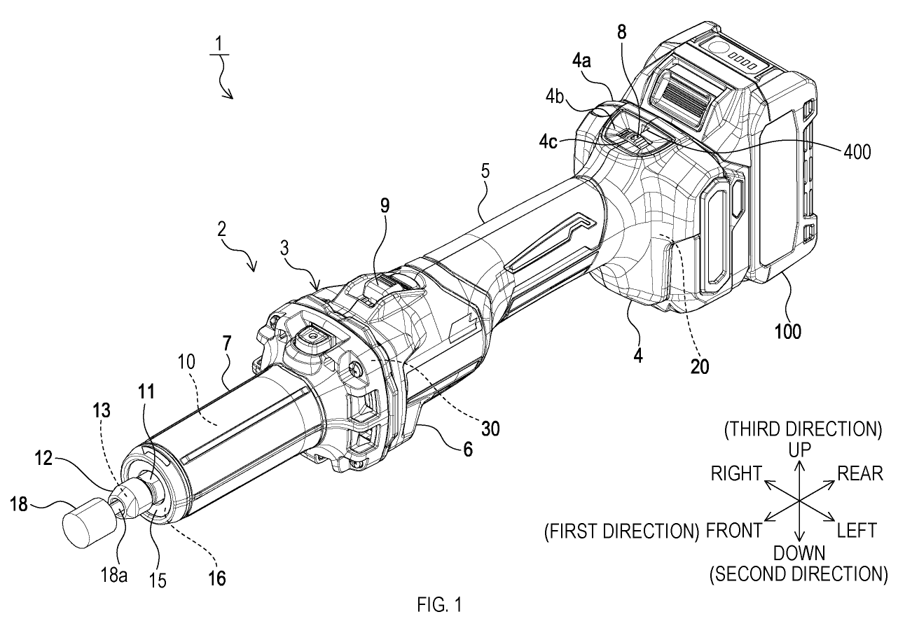

The following embodiment provides a handheld grinder 1 (hereinafter referred to as a "grinder 1") shown in FIG. 1. The grinder 1 is configured to process various workpieces (or materials to be processed). Specifically, the grinder 1 is capable of grinding and/or polishing workpieces. The grinder 1 may further be capable of performing operations other than grinding and polishing (for example, cutting workpieces).

For convenience of explanation, the directions of the grinder 1 are defined as shown in FIG. 1 and the following figures. Specifically, the terms "up" (an upward direction), "down" (a downward direction), "right" (a rightward direction), "left" (a leftward direction), "front" (a forward direction), and "rear" (a rearward direction) are defined. These directions are used solely to facilitate understanding of the structure of the grinder 1, and are not intended to limit the orientation of the grinder 1. The grinder 1 may be facing in any direction.

### 2-1. Mechanical Configuration of Grinder

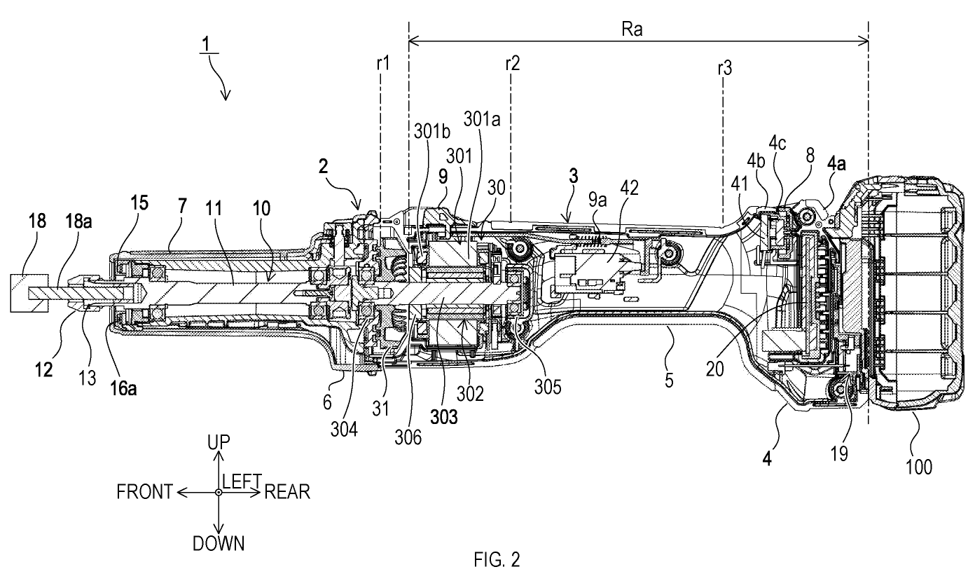

As shown in FIGS. 1 and 2, the grinder 1 includes a main body 2 and a battery 100. In this embodiment, the battery 100 has a rated voltage of 36V. The battery 100 is capable of supplying its electric power (hereinafter referred to as a "battery power") to the main body 2. The battery 100 is one example of a power source described in the overview of the embodiment.

The main body 2 includes a housing 3. The housing 3 of the present embodiment is hollow and has a substantially cylindrical shape. The housing 3 extends along a first direction. In the present embodiment, the first direction is defined as the forward direction.

The main body 2 includes a collet chuck 13 and a collet nut 12 arranged forward of the housing 3. The collet chuck 13 is arranged at a front end of a spindle 11 described below. The spindle 11 has a hollow cylindrical shape and includes a first opening at its front end. The first opening faces forward. The collet chuck 13 is inserted into the spindle 11 through the first opening and is capable of rotating integrally with the spindle 11. The collet nut 12 is screwed onto the spindle 11 from its front end, while the collet chuck 13 is inserted into the spindle 11.

The collet chuck 13 is configured to detachably attach a machining tool 18. The machining tool 18 may be any type capable of machining a workpiece. The machining tool 18 may include a grinding wheel, for example. The machining tool 18 provided with a grinding wheel may be referred to as a "grinding tool 18," a "grinding wheel 18," or simply a "wheel 18."

The machining tool 18 of the present embodiment includes a support shaft (or an arbor or a mandrel) 18a. The support shaft 18a is fixed to (i.e., integrated with) the machining tool 18. In the present embodiment, the term "machining tool 18" refers to an integrally formed component including the support shaft 18a. However, the "machining tool 18" may be distinguished from the support shaft 18a. The support shaft 18a may be detachably attached to the machining tool 18. FIGS. 1 and 2 show a state in which the machining tool 18 is attached to the collet chuck 13.

When the machining tool 18 is attached to the main body 2, the collet nut 12 is first loosened, the support shaft 18a is then inserted into the collet chuck 13, and subsequently the collet nut 12 is rotated in a tightening direction. As a result, the collet chuck 13 clamps the support shaft 18a around its periphery, thereby attaching (i.e., fixing) the support shaft 18a to the collet chuck 13.

When the machining tool 18 is attached to the collet chuck 13 in this manner and a motor 30 described later rotates, the rotational force causes the collet chuck 13 to rotate together with the spindle 11, thereby rotating the machining tool 18. A user of the grinder 1 can rotate the collet nut 12 in a loosening direction, causing the collet chuck 13 to release the clamping of the support shaft 18a, thereby detaching the support shaft 18a (and consequently the machining tool 18) from the collet chuck 13.

The housing 3 includes a controller container 4 at its rear end. The controller container 4 houses the controller 20 therein. The controller container 4 includes a battery port 4a at its rear end. That is, the battery port 4a is arranged on an outer surface of the housing 3, specifically at its rear end.

The battery port 4a is configured to detachably attach the battery 100. FIGS. 1 and 2 show a state in which the battery 100 is attached to the battery port 4a. The battery port 4a includes a terminal block 19 configured to be electrically coupled to the battery 100. The terminal block 19 includes two or more device-side terminals (not shown). The battery 100 includes two or more battery-side terminals (not shown) configured to be respectively in contact with, and electrically coupled to, the two or more device-side terminals. When the battery 100 is attached to the battery port 4a, the two or more battery-side terminals are connected to the two or more device-side terminals. This allows the main body 2 to receive the battery power from the battery 100 via the battery port 4a, specifically through the terminal block 19. The battery port 4a and/or the terminal block 19 are examples of the power port described in the overview of the embodiment.

In the present embodiment, the battery 100 is attached to the battery port 4a by sliding it in a second direction from the upper end of the battery port 4a. The second direction is the downward direction. When the battery 100 is attached to the battery port 4a, the battery 100 is locked to the battery port 4a. Then, when the lock is released and the battery 100 is slid in a third direction (or a detachment direction), the battery 100 is detached from the battery port 4a. The third direction is opposite to the second direction (i.e., the upward direction).

The controller container 4 includes two or more surfaces. The two or more surfaces include a surface region 4b that faces upward. When the user views the grinder 1 downward from above (i.e., in the second direction), the surface region 4b is visible.

The surface region 4b includes a second opening 4c. The controller container 4 houses a first manual operating device 8 therein. A part of the first manual operating device 8 is exposed through the second opening 4c and protrudes (or is exposed) outside the second opening 4c. A reference position is defined on the surface region 4b in the vicinity of the second opening 4c. A reference position mark 400 is provided at the reference position. The second opening 4c is one example of the opening described in the overview of the embodiment.

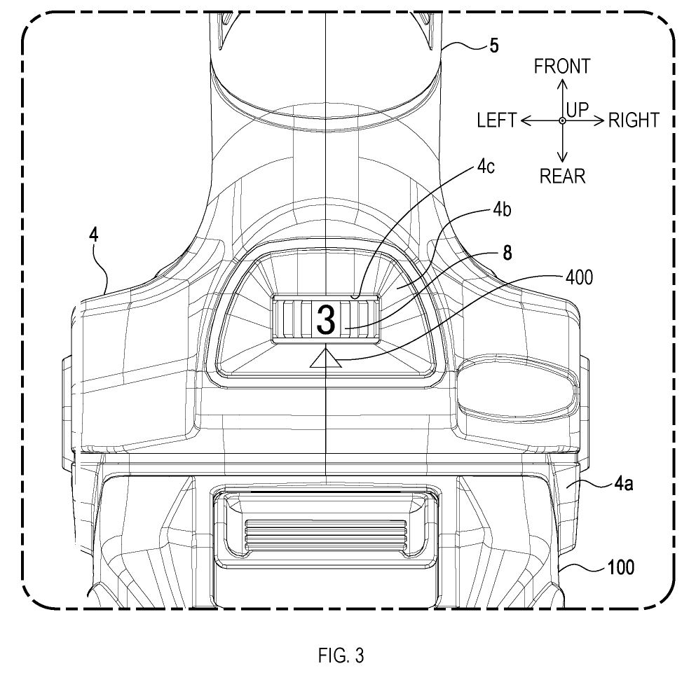

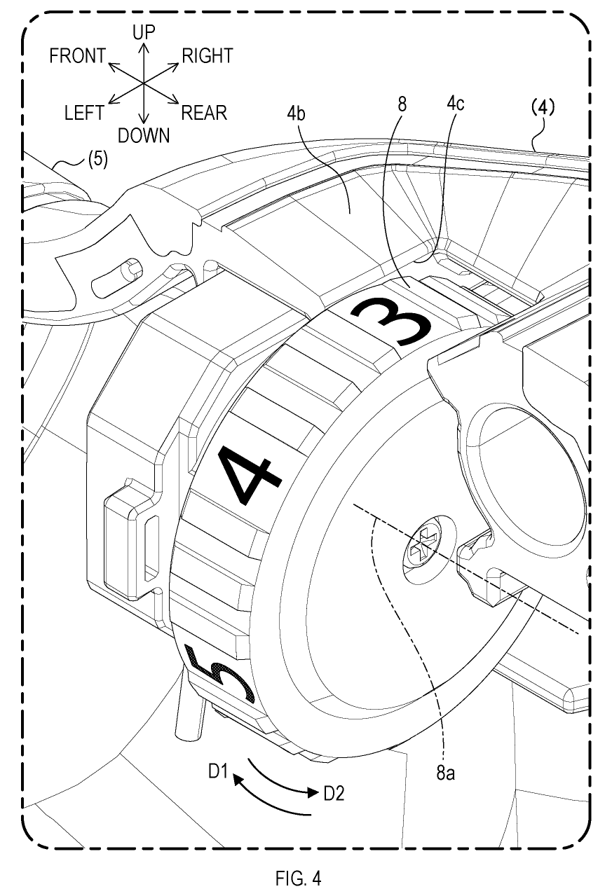

As shown in detail in FIGS. 3 and 4, the first manual operating device 8 of the present embodiment is in the form of a rotatable body (specifically, a dial, a rotor, or a knob). That is, the first manual operating device 8 has a thin cylindrical shape (i.e., a shape similar to a thick coin). The first manual operating device 8 is rotatable about an axis 8a (see FIG. 4). In the present embodiment, the axis 8a is parallel or substantially parallel to the front-rear direction.

On the outer circumferential surface of the first manual operating device 8, two or more speed setting values are marked to be spaced apart from each other along the rotational direction of the first manual operating device 8. In the present embodiment, the two or more speed setting values are "1" to "5". The two or more speed setting values respectively correspond to desired rotational speeds that are distinct from each other. The greater the speed setting value, the greater the corresponding target rotational speed. That is, the lowest desired rotational speed corresponds to the speed setting value "1", and the greatest desired rotational speed corresponds to the speed setting value "5". The number of speed setting values may be four or less, or six or more. The positions where the two or more speed setting values are marked are examples of the two or more speed setting positions described in the overview of the embodiment.

Hereinafter, aligning any one of the speed setting values with the reference position mark 400 is referred to as "specifying a speed setting value" (or "a speed setting value is specified"). For example, the phrase "speed setting value '2' is specified" means that the speed setting value '2' marked on the first manual operating device 8 is aligned with the reference position mark 400. Aligning one of the speed setting values with the reference position mark 400 means that the speed setting value (more specifically, a position where the speed setting value is marked) on the first manual operating device 8 is aligned with the reference position mark 400 in the front-rear direction. The speed setting value aligned with the reference position mark 400 is hereinafter referred to as a "specified setting value".

When any one of the speed setting values is specified via the first manual operating device 8, the desired rotational speed corresponding to the speed setting value is set as a desired rotational speed for the motor 30. That is, the desired rotational speed corresponding to the speed setting value is set as the desired rotational speed to be used for controlling the motor 30 (e.g., in a speed feedback control described later). In other words, the desired rotational speed corresponding to the speed setting value is enabled and used to control the motor 30. FIGS. 3 and 4 illustrate a state in which the speed setting value "3" is specified. In this case, the desired rotational speed corresponding to the speed setting value "3" is set as the desired rotational speed of the motor 30.

The specified setting value increases in response to the first manual operating device 8 being rotated in a first rotational direction D1 (see FIG. 4). The specified setting value decreases in response to the first manual operating device 8 being rotated in a second rotational direction D2 (see FIG. 4). The second rotational direction D2 is opposite to the first rotational direction D1. Therefore, when the first manual operating device 8 is rotated from the state shown in FIGS. 3 and 4 in the first rotational direction D1, the speed setting values "4" and "5" sequentially come to face the reference position mark 400. Conversely, when the first manual operating device 8 is rotated from the state shown in FIGS. 3 and 4 in the second rotational direction D2, the speed setting values "2" and "1" sequentially come to face the reference position mark 400.

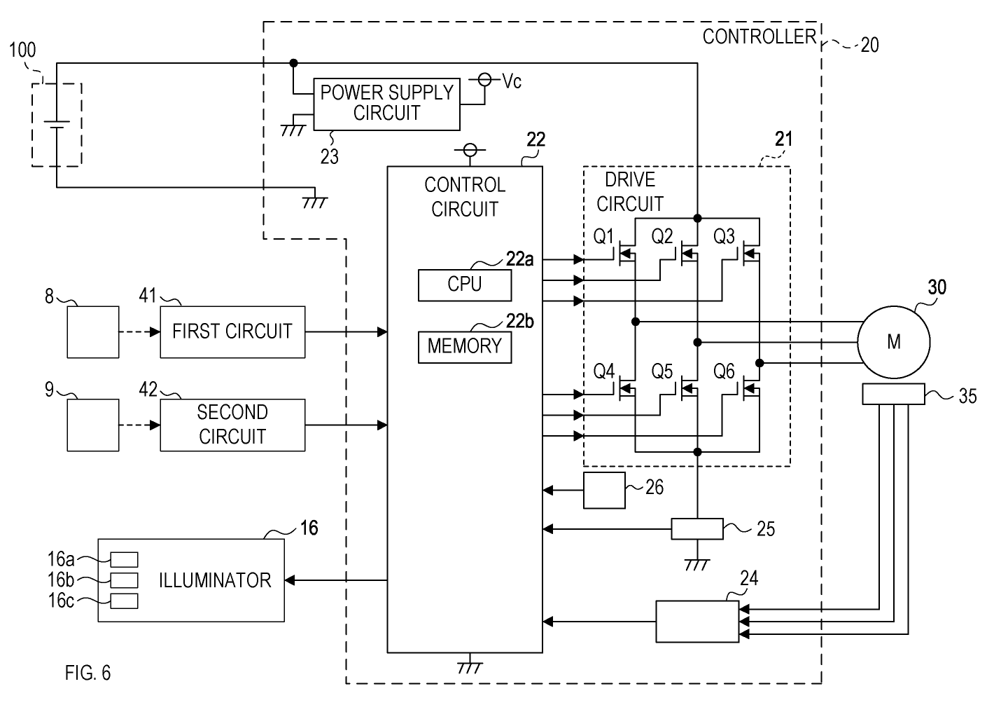

The rotational position of the first manual operating device 8 (i.e., the specified speed setting value) is converted into an electrical signal by a first circuit 41 (see FIGS. 2 and 6) described below and transmitted to a control circuit 22 (see FIG. 6) described below.

In the present embodiment, the first manual operating device 8 cannot make one full revolution (i.e., 360 degrees), and its rotatable range is restricted. Specifically, the rotatable range of the first manual operating device 8 extends from a first rotational position to a second rotational position. This rotatable range is less than 360 degrees. The first rotational position is a position where the speed setting value "1" is aligned with the reference position mark 400, or a position obtained by rotating the first manual operating device 8 by a first specified angle in the second rotational direction D2 from the position. Further rotation in the second rotational direction D2 from the first rotational position is restricted, for example, by a first stopper (not shown). The second rotational position is a position where the speed setting value "5" is aligned with the reference position mark 400, or a position obtained by rotating the first manual operating device 8 by a second specified angle in the first rotational direction D1 from that position. Further rotation from the second rotational position in the first rotational direction D1 is restricted, for example, by a second stopper (not shown). The first manual operating device 8 may be rotatable without restriction on its rotatable range.

The grinder 1 includes a first circuit 41 (see FIG. 2). In the present embodiment, the first circuit 41 is arranged inside the controller container 4. The first circuit 41 is associated with the first manual operating device 8. Specifically, the first circuit 41 outputs a first signal corresponding to the rotational position of the first manual operating device 8. That is, the first signal indicates the rotational position of the first manual operating device 8. More specifically, the first signal indicates which speed setting value is specified by the first manual operating device 8, or in other words, which of the two or more speed setting values "1" to "5" is aligned with the reference position mark 400.

The first circuit 41 may be configured in any manner. The first circuit 41 of the present embodiment outputs the first signal that varies continuously in response to the rotational position of the first manual operating device 8. Specifically, the first signal has a voltage, and the magnitude of this voltage varies continuously in response to the rotational position of the first manual operating device 8. However, the magnitude of the voltage of the first signal may vary in a stepwise manner. Thus, the grinder 1 of the present embodiment is provided with a first input device including the first manual operating device 8 and the first circuit 41. This first input device is in the form of a potentiometer.

The first manual operating device 8 and the first circuit 41 may be in the form of a rotary switch other than the potentiometer, for example. Specifically, the first circuit 41 may be configured to output one of two or more first signals respectively corresponding to the two or more speed setting values. That is, the first circuit 41 may include two or more signal output terminals that respectively correspond to the two or more first signals. The first circuit 41 may output one of the first signals, the one corresponding to the rotational position of the first manual operating device 8 (i.e., the specified speed setting value), from the corresponding signal output terminal.

The housing 3 includes a first grip 5 arranged forward of the controller container 4. In the present embodiment, the first grip 5 extends forward. The first grip is configured to be gripped by the user.

The housing 3 includes a motor container 6 arranged forward of the first grip 5. The motor container 6 houses the motor 30. In the present embodiment, the motor 30 is an inner rotor brushless motor (specifically, a three-phase brushless DC motor). In another embodiment, the motor 30 may be any other type of motor, such as a brushed DC motor.

As shown in FIG. 2, the motor 30 includes a stator 301 and a rotor 302. The stator 301 includes two or more teeth 301a and two or more coils 301b. The two or more coils 301b are respectively wound around the two or more teeth 301a. The two or more coils 301b are connected in a delta configuration or a star configuration.

The rotor 302 is rotatably arranged inside the stator 301. The rotor 302 includes two or more permanent magnets that are arranged within the rotor 302 and spaced apart from each other along the rotational direction. The motor 30 includes a rotor shaft 303 that is fixed to the rotor 302 so as to extend along the rotational axis of the rotor 302. The rotor shaft 303 rotates integrally with the rotor 302. The rotational axis of the rotor 302 coincides with a rotational axis of the rotor shaft 303.

The motor 30 includes a first bearing 304 and a second bearing 305 rotatably supporting the rotor shaft 303. The first bearing 304 is arranged forward of the rotor 302, and the second bearing 305 is arranged rearward of the rotor 302. The motor 30 includes a sleeve 306 fitted around the rotor shaft 303. The sleeve 306 is fixed to the rotor shaft 303 and rotates integrally with the rotor shaft 303. The sleeve 306 is provided to balance the rotor 302 during rotation and reduce vibration and the like. The sleeve 306 is cut or machined, as necessary. The first bearing 304, the second bearing 305, and the sleeve 306 may be regarded as components separate from the motor 30.

The motor 30 includes three terminals (not shown) electrically coupled to a controller 20 (specifically, to a drive circuit 21 described below). The two or more coils 301b are electrically coupled to the three terminals. The motor 30 receives a three-phase power from the controller 20 via the three terminals, thereby rotating.

The housing 3 includes a fan 31 arranged forward of the motor 30. The fan 31 is attached to the rotor shaft 303 and rotates integrally with the rotor shaft 303. The fan 31 is configured to cool the motor 30.

The grinder 1 includes a second manual operating device 9 provided at the top of the housing 3. In the present embodiment, the second manual operating device 9 is arranged at the top of the motor container 6. In the present embodiment, the second manual operating device 9 is in the form of a slider (or a slide lever).

The second manual operating device 9 is manually operated by the user to instruct driving (i.e., rotation) or stopping of the motor 30. For example, the user may slide the second manual operating device 9 in the front-rear direction with a finger (e.g., a thumb) of one hand while gripping the first grip 5 with the same hand.

The second manual operating device 9 is biased rearward by an elastic body 9a (see FIG. 2). Therefore, when the second manual operating device 9 is not touched by the user, the second manual operating device 9 remains in its initial position. FIGS. 1 and 2 show the second manual operating device 9 in its initial position.

When the second manual operating device 9 is manually pushed forward from its initial position by the user, the second manual operating device 9 moves (i.e., slides) forward from its initial position and reaches an ON position. The manual operation of moving the second manual operating device 9 to the ON position is an example of the third manual operation in the overview of embodiments. The second manual operating device 9 includes an ON-holding mechanism. The ON-holding mechanism holds the second manual operating device 9, which has reached the ON position, in the ON position. The user can use this ON-holding mechanism to retain the second manual operating device 9 in the ON position. The user can release the retention by the ON-holding mechanism, for example, by pressing a rear end portion of the second manual operating device 9. When the retention by the ON-holding mechanism is released, the second manual operating device 9 returns to its initial position due to the elastic force of the elastic body 9a.

The second manual operating device 9 does not necessarily include the ON-holding mechanism and/or the elastic body 9a. The second manual operating device 9 may need to be manually slid rearward to move it from the ON position to its initial position.

The grinder 1 includes a second circuit 42 (see FIG. 2). In the present embodiment, the second circuit 42 is arranged inside the first grip 5. The second circuit 42 is in association with the second manual operating device 9. The second circuit 42 outputs a second signal while the second manual operating device 9 is in the ON position.

The second circuit 42 may be configured in any manner. The second circuit 42 may include an electrical switch (not shown). The electrical switch may be turned on (i.e., opened) or turned off (closed) in association with the second manual operating device 9. The electrical switch may be turned off when the second manual operating device 9 is in its initial position, and may be turned on when the second manual operating device 9 is in the ON position. The second circuit 42 may output the second signal while the electrical switch is turned on (i.e., while the second manual operating device 9 is in the ON position).

The housing 3 includes a second grip 7 forward of the motor container 6. In the present embodiment, the second grip 7 extends forward. The second grip 7 is configured to be gripped by the user. The user can use the grinder 1 while gripping the first grip 5 and the second grip 7 with both hands.

The housing 3 houses a transmission device (or transmission portion) 10 forward of the motor 30. The transmission device 10 transmits the rotation of the motor 30 to the collet chuck 13. The transmission device 10 includes the aforementioned spindle 11. The spindle 11 is connected to the rotor shaft 303 and the collet chuck 13. As described above, the collet chuck 13 is arranged at the front end of the spindle 11. When the motor 30 rotates (i.e., the rotor shaft 303 rotates), the spindle 11 rotates, thereby rotating the collet chuck 13.

The grinder 1 includes an illuminator 16. In the present embodiment, the illuminator 16 is arranged at the front end of the second grip 7 (i.e., the front end of the housing 3). The illuminator 16 emits light frontward of the grinder 1. The illuminator 16 is configured to emit light toward at least a portion of the machining tool 18 and/or the workpiece being processed by the machining tool 18 (i.e., the workpiece in contact with the machining tool 18).

The grinder 1 includes a lighting cover 15 arranged forward of the illuminator 16. The illuminator 16 is covered by the lighting cover 15. The lighting cover 15 is configured to allow light to pass through. Therefore, some or all of the light emitted from the illuminator 16 passes through the lighting cover 15 and is emitted toward the front of the grinder 1.

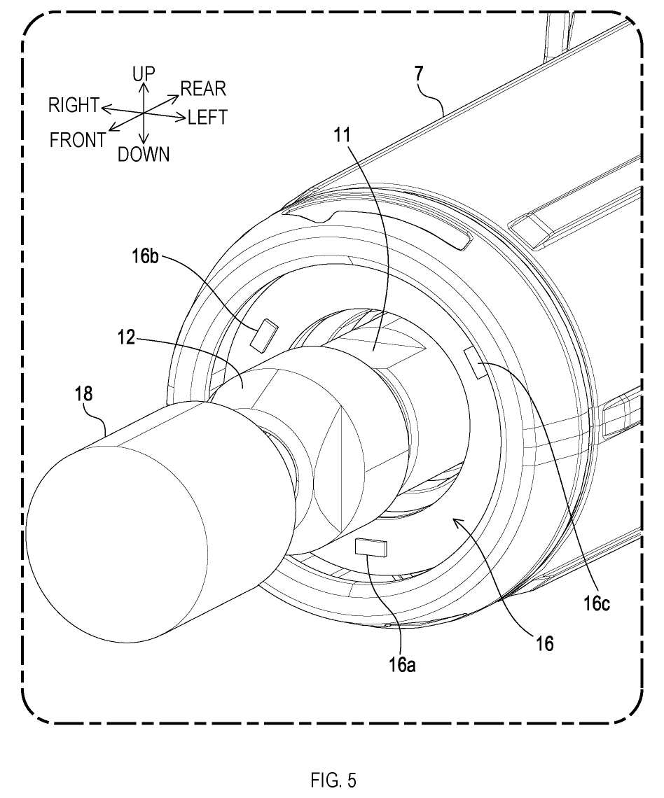

As shown in FIG. 5, the illuminator 16 of the present embodiment includes two or more LEDs. In the present embodiment, the two or more LEDs include three LEDs 16a, 16b, and 16c. The illuminator 16 may include any number of LEDs. The illuminator 16 may also include a light source other than LEDs.

In the present embodiment, as described below, the illuminator 16 is configured to be lit or blink according to various lighting patterns. By way of example only, in the following description, the term "lit or blink" regarding the illuminator 16 means that the three LEDs 16a, 16b, and 16c are lit or blink simultaneously.

One of the features of the present embodiment is that, as shown in FIG. 2, the first manual operating device 8 is arranged within a specified region (or an operating device arrangement region) Ra. The specified region Ra is a region (or an area) extending from the motor 30 to the battery port 4a along the first direction. The front end of the specified region Ra is the front end of the motor 30 (e.g., the front end of the sleeve 306). The rear end of the specified region Ra is a rear end of the housing 3. More specifically, the rear end of the specified region Ra is a rear end of the battery port 4a. In other words, the specified region Ra corresponds to a region between a first end surface and a second end surface. The first end surface is perpendicular to the first direction and passes through the front end of the motor 30. The second end surface is perpendicular to the first direction and passes through the rear end of the battery port 4a.

The front end of the specified region Ra may differ from the front end of the motor 30. For example, the front end within the specified region Ra may be a fan front end r1. The fan front end r1 is a front end of the fan 31. The fan 31 may be regarded as one of the components of the motor 30. In this case, the front end of the specified region Ra (i.e., the fan front end r1) may be referred to as the front end of the motor 30.

The front end of the specified region Ra may be located rearward of the sleeve 306. However, in this case, the front end of the specified region Ra may be located forward of the rear end of the motor 30. For example, a front end of the coil 301b may be the front end of the specified region Ra. Alternatively, for example, the front end of the specified region Ra may be a grip front end r2. The grip front end r2 is a front end of the first grip 5.

Alternatively, the front end of the specified region Ra may be located rearward of the motor 30. For example, the front end of the specified region Ra may be located between the grip front end r2 and a grip rear end r3. The grip rear end r3 is a rear end of the first grip 5.

Alternatively, the front end of the specified region Ra may be located in the vicinity of the rear end of the first grip 5. Specifically, the front end of the specified region Ra may coincide with the grip rear end r3. That is, the front end of the specified region Ra may be determined such that it exists rearward of the user's hand when the user grips the first grip 5 with one hand (i.e., such that the first manual operating device 8 exists rearward of that hand).

The rear end of the specified region Ra may be located forward of the rear end of the battery port 4a. The rear end of the specified region Ra may be a rear end of a portion that actually receives the battery power in the battery port 4a (i.e., a portion with which the battery 100 is in contact and to which the battery power is input). More specifically, the battery power is input to the terminal block 19 (more specifically, to the device-side terminals) of the battery port 4a. Therefore, the rear end of the specified region Ra may be a rear end of the terminal block 19 or the rearmost end of the device-side terminals.

In the present embodiment, the housing 3 extends substantially linearly along the front-rear direction. However, the housing 3 may extend along a line that includes a curve. That is, the housing 3 may be bent at certain portions while extending along the first direction overall.

### 2-2. Electrical Configuration of Grinder

An electrical configuration of the grinder 1 is described with reference to FIG. 6. The grinder 1 includes the motor 30 and the controller 20. The battery 100 is electrically coupled to the controller 20 based on the battery 100 being attached to the battery port 4a. FIG. 6 illustrates a state in which the battery 100 is attached to the battery port 4a. The controller 20 supplies the three-phase power to the motor 30 to drive the motor 30 and controls the supply of the three-phase power.

The controller 20 includes a circuit board (not shown). Many (or all) of the various circuits, components, and wiring that constitute the controller 20 are mounted on the circuit board. However, a part of the circuits, components, and wiring that constitute the controller 20 may be located outside the circuit board.

The controller 20 includes a drive circuit 21 configured to drive the motor 30. The drive circuit 21 is electrically coupled to the positive and negative electrodes of the battery 100 and receives the battery power from the battery 100.

In the present embodiment, the drive circuit 21 is a three-phase full-bridge circuit. However, the drive circuit 21 is not limited to the three-phase full-bridge circuit. The drive circuit 21 includes first to third switch elements Q1 to Q3 arranged on the high side and fourth to sixth switch elements Q4 to Q6 arranged on the low side. Each of the first to third switch elements Q1 to Q3 is electrically coupled to the positive electrode of the battery 100 and a corresponding terminal in the motor 30, functioning as a so-called high-side switch. Each of the fourth to sixth switch elements Q4 to Q6 is electrically coupled to a corresponding terminal in the motor 30 and the negative electrode of the battery 100, functioning as a so-called low-side switch.

The first to sixth switch elements Q1 to Q6 respectively receive first to sixth drive control signals from the control circuit 22. Each of the first to sixth switch elements Q1 to Q6 turns on or off in response to the corresponding one of the first to sixth drive control signals. In the present embodiment, the first to sixth drive control signals may be pulse width modulated signals. The first to sixth switch elements Q1 to Q6 of the present embodiment are semiconductor switches, more specifically field-effect transistors (FETs). However, the first to sixth switch elements Q1 to Q6 may be semiconductor switches other than FETs, such as bipolar transistors, insulated-gate bipolar transistors (IGBTs), or the like.

When the motor 30 is driven, basically any one of the high-side switches and any one of the low-side switches are turned on. This allows a current (hereinafter referred to as a "motor drive current") to flow from the positive electrode of the battery 100 through the high-side switch, the motor 30, and the low-side switch to the negative electrode of the battery 100. The motor 30 rotates as a result of the motor drive current flowing through the motor 30.

The controller 20 includes a power supply circuit 23. The power supply circuit 23 is electrically coupled to the positive and negative electrodes of the battery 100. The power supply circuit 23 receives the battery power from the battery 100. The power supply circuit 23 generates a fixed DC voltage (hereinafter referred to as a "power supply voltage") Vc from the battery power. The power supply voltage Vc is supplied to various portions within the controller 20.

The controller 20 includes a current detection circuit 25. The current detection circuit 25 is provided on the negative electrode line. The negative electrode line electrically couples the drive circuit 21 to the negative electrode of the battery 100. The current detection circuit 25 outputs a current detection signal corresponding to a magnitude of the motor drive current flowing through the negative electrode line.

The controller 20 includes a temperature detection circuit 26. The temperature detection circuit 26 is provided to detect the temperature of the drive circuit 21 (specifically, the temperature of the first to sixth switch elements Q1 to Q6). The temperature detection circuit 26 is provided in the vicinity of the drive circuit 21 (specifically, in the vicinity of the first to sixth switch elements Q1 to Q6) in view of its installation purpose. The temperature detection circuit 26 outputs a temperature detection signal corresponding to the temperature around the temperature detection circuit 26.

The grinder 1 includes a rotation detection device for detecting a rotational state of the motor 30 (specifically, the rotor 302). The rotational state includes an actual rotational speed and/or a rotational position (i.e., a rotational angle). The rotation detection device of the present embodiment includes a rotation sensor 35.

The rotation sensor 35 includes three Hall sensors (not shown). Each of the three Hall sensors includes a Hall element. The three Hall sensors are (i) arranged around the rotor 302 and (ii) output first to third rotation signals corresponding to the rotational position of the rotor 302 (i.e., the rotational position of the rotor shaft 303). Each of the first to third rotation signals is, for example, a sine wave signal. The voltage of each of the first to third rotation signals is inverted from positive to negative or from negative to positive each time the rotor 302 rotates by 180 degrees in electrical angle. The first to third rotation signals have a phase difference of 120 degrees in electrical angle with respect to each other. Each of the first to third rotation signals may be a pulse signal. The logic level of that pulse signal may switch each time the rotor 302 rotates by 180 degrees in electrical angle.

The controller 20 includes a position detection circuit 24. The position detection circuit 24 receives the first to third rotation signals from the rotation sensor 35. The position detection circuit 24 outputs a position detection signal based on the first to third rotation signals. The position detection signal indicates the rotational state of the motor 30. Specifically, the position detection signal may be a pulse signal whose logic level is inverted every 60 degrees in electrical angle.

The controller 20 includes a control circuit 22. When the battery 100 is attached to the battery port 4a, the power supply circuit 23 generates the power supply voltage Vc. The control circuit 22 is activated upon receipt of the power supply voltage Vc and continues to operate while receiving the power supply voltage Vc.

The control circuit 22 includes a microcomputer including a CPU 22a and a memory 22b. The memory 22b includes, for example, a ROM, a RAM, and a rewritable non-volatile memory. The non-volatile memory may be, for example, an EEPROM, a flash memory, a ReRAM, or a FeRAM. Various functions of the control circuit 22 are performed by the CPU 22a executing a program stored in the memory 22b. Execution of the program by the CPU 22a causes processing corresponding to the program to be performed.

In another embodiment, the control circuit 22 may include an additional microcomputer. In yet another embodiment, some or all of the functions performed by the CPU 22a may be achieved by one or more electronic components (e.g., integrated circuits). In yet another embodiment, the control circuit 22 may be a logic circuit (or a wired logic connection) including two or more electronic components. In yet another embodiment, the control circuit 22 may include an ASIC and/or an ASSP. In yet another embodiment, the control circuit 22 may include a programmable logic device in which a reconfigurable logic circuit may be constructed. Examples of the programmable logic device include an FPGA.

The control circuit 22 is connected to a first circuit 41 and receives a first signal from the first circuit 41. Based on the first signal, the control circuit 22 can detect (or identify) a speed setting value specified by the first manual operating device 8. Specifically, the control circuit 22 can detect the specified speed setting value based on the voltage value of the first signal.

More specifically, the control circuit 22 detects that the speed setting value "1" is specified when the voltage value of the first signal is within a first range, detects that the speed setting value "2" is specified when the voltage value of the first signal is within a second range, detects that the speed setting value "3" is specified when the voltage value of the first signal is within a third range, detects that the speed setting value "4" is specified when the voltage value of the first signal is within a fourth range, and detects that the speed setting value "5" is specified when the voltage value of the first signal is within a fifth range.

The first to fifth ranges are set so as to be either adjacent to or separated from each other, without overlapping with one another. As merely an example for illustrative purposes, the first range may be 1V or more and less than 1.5V, the second range may be 1.5V or more and less than 2V, the third range may be 2V or more and less than 2.5V, the fourth range may be 2.5V or more and less than 3V, and the fifth range may be 3V or more and less than 3.5V.

The first manual operating device 8 is capable of receiving both a first manual operation and a second manual operation. In other words, the control circuit 22 can detect that the first manual operation and the second manual operation have been performed on the first manual operating device 8.

The first manual operation is to set an operation mode of the illuminator 16. The first manual operation will be described below.

The second manual operation is to set the speed setting value, i.e., to align one of the speed setting values "1" to "5" with the reference position mark 400. The control circuit 22 sets a desired rotational speed of the motor 30 in response to the second manual operation (i.e., in response to the specified speed setting value). The function of setting the desired rotational speed in response to the second manual operation is an example of the specified function in the overview of the embodiment.

The control circuit 22 is coupled to a second circuit 42 and receives a second signal from the second circuit 42. Based on receiving the second signal, the control circuit 22 can detect that the second manual operating device 9 has been moved to the ON position.

The control circuit 22 is coupled to the position detection circuit 24 and receives the position detection signal from the position detection circuit 24. Based on the position detection signal, the control circuit 22 can detect the rotational state of the motor 30.

The position detection circuit 24 may be incorporated into the control circuit 22. That is, the control circuit 22 may include the function of the position detection circuit 24. Alternatively, the rotation sensor 35 may include the function of the position detection circuit 24.

The control circuit 22 may detect the rotational state of the motor 30 by other methods. For example, the control circuit 22 may detect the rotational state using a sensor distinct from the rotation sensor 35 (i.e., distinct from the Hall sensor). Furthermore, the control circuit 22 may detect the rotational state by a so-called sensorless method, without using sensors. In the sensorless method, the rotational state is detected based on an induced voltage generated at the three terminals of the motor 30 during rotation of the motor 30.

The control circuit 22 is coupled to the current detection circuit 25 and receives the current detection signal from the current detection circuit 25. The control circuit 22 can detect the magnitude of the motor drive current based on the current detection signal.

The control circuit 22 detects that the grinder 1 is in an overcurrent state based on the magnitude of the detected motor drive current being greater than a specified upper limit. When the grinder 1 is operating properly, the magnitude of the motor drive current does not exceed, or is less likely to exceed, the specified upper limit. The control circuit 22 filters the detected magnitude of the motor drive current. The filtering includes, for example, removing high-frequency components. The control circuit 22 may determine whether the grinder 1 is in the overcurrent state based on the filtered magnitude of the motor drive current.

When the overcurrent state is detected, the control circuit 22 detects that the grinder 1 is in an abnormal state (or faulty state). The abnormal state may include two or more specific states, including the overcurrent state. The control circuit 22 may detect that the grinder 1 is in the abnormal state when one or more of the specific states are detected.

The control circuit 22 further estimates the temperature of the motor 30 (hereinafter referred to as a "motor temperature") based on the magnitude of the motor drive current. The control circuit 22 may estimate the motor temperature by any method. For example, the control circuit 22 may estimate the motor temperature based on the duration of a high-current state. The high-current state corresponds to a state in which the magnitude of the motor drive current is equal to or greater than a specified current threshold. The specified current threshold is smaller than the aforementioned specified upper limit. The specified current threshold may occur even when the grinder 1 is operating properly. The control circuit 22 may increase the estimated motor temperature with an increase in the duration of the high-current state.

The control circuit 22 detects that the grinder 1 is in a motor overheated state based on the estimated motor temperature having reached a first temperature threshold (in other words, based on the high-current state continuing for a certain period or longer). The term "motor overheated state" refers to a state in which the motor 30 is in an overheated state. When the grinder 1 is operating properly, the motor temperature does not reach, or is less likely to reach, the first temperature threshold.

The control circuit 22 is coupled to the temperature detection circuit 26 and receives the temperature detection signal from the temperature detection circuit 26. Based on the temperature detection signal, the control circuit 22 can detect the temperature of the drive circuit 21 (hereinafter referred to as a "circuit temperature").

The control circuit 22 detects that the grinder 1 is in a circuit overheated state based on the detected circuit temperature being equal to or greater than a second temperature threshold. The term "circuit overheated state" refers to a state in which the drive circuit 21 is in an overheated state. When the grinder 1 is operating properly, the circuit temperature does not reach, or is less likely to reach, the second temperature threshold. The control circuit 22 filters the detected circuit temperature. The control circuit 22 may determine whether the grinder 1 is in the circuit overheated state based on the filtered circuit temperature.

The control circuit 22 is coupled to the drive circuit 21. The control circuit 22 basically outputs the first to sixth drive control signals to the drive circuit 21 while receiving the second signal, thereby driving the motor 30. Specifically, the control circuit 22 detects the rotational position of the motor 30 based on the position detection signal and turns on the switch elements according to that rotational position.

The control circuit 22 may control the driving of the motor 30 by any control method. In the present embodiment, as merely one example, the control circuit 22 controls the driving of the motor 30 using speed feedback control. That is, based on the first signal from the first circuit 41, the control circuit 22 sets, as the desired rotational speed of the motor 30, a desired rotational speed corresponding to the specified speed setting value. In other words, the control circuit 22 enables the desired rotational speed corresponding to the specified speed setting value. Then, the control circuit 22 (i) detects the actual rotational speed of the motor 30 based on the position detection signal, and (ii) determines a duty ratio based on that actual rotational speed and the desired rotational speed that has been set (i.e., enabled). The duty ratio is determined such that the actual rotational speed matches the desired rotational speed. The control circuit 22 then outputs the drive control signals to the drive circuit 21. The drive control signals include a drive control signal having the determined duty ratio. In this manner, the control circuit 22 controls the driving of the motor 30 such that the actual rotational speed of the motor 30 matches the desired rotational speed.

However, even when receiving the second signal, the control circuit 22 stops the motor 30 if the aforementioned abnormal state is detected.

The control circuit 22 sets the grinder 1 to a high-temperature error state if the aforementioned motor overheated state and/or the circuit overheated state is detected. The control circuit 22 does not drive the motor 30 even when receiving the second signal, while the grinder 1 is set to the high-temperature error state.

The control circuit 22 is coupled to the illuminator 16. The control circuit 22 is configured to control the operation of the illuminator 16. The control circuit 22 activates or deactivates the illuminator 16 in accordance with various conditions.

### 2-3. Operation of Illuminator

The control of the illuminator 16 by the control circuit 22 is described in detail below. The control circuit 22 sets the operation mode of the illuminator 16 to either a light-on mode or a light-off mode. Each time the operation mode is switched, the control circuit 22 stores, in the memory 22b (specifically, in the non-volatile memory), a new operation mode after switching. Switching the operation mode includes switching the operation mode from the light-on mode to the light-off mode and switching the operation mode from the light-off mode to the light-on mode.

The light-on mode is an operation mode in which the illuminator 16 is activated (or is turned on) (i.e., the illuminator 16 emits light toward the front of the grinder 1). The light-off mode is an operation mode in which the illuminator 16 is not activated (or is turned off) (i.e., the illuminator 16 does not emit light toward the front of the grinder 1).

In response to the battery 100 being attached to the battery port 4a (specifically, in response to the control circuit 22 receiving the power supply voltage Vc and being activated), the control circuit 22 (i) reads the operation mode (i.e., the light-on mode or the light-off mode) stored in the memory 22b, and (ii) sets the operation mode of the illuminator 16 to the read operation mode.

When the operation mode is set to the light-on mode and the second manual operating device 9 is moved to the ON position, the control circuit 22 controls the illuminator 16 to emit light (or to turn on) (i.e., activates the illuminator 16). In this case, the control circuit 22 continuously keeps the illuminator 16 emitting light while the second manual operating device 9 remains in the ON position. When the second manual operating device 9 is moved from the ON position to the initial position, the control circuit 22 controls the illuminator 16 not to emit light (or to turn off) (i.e., deactivates the illuminator 16). In this case, the control circuit 22 may control the illuminator 16 not to emit light immediately after the second manual operating device 9 is moved to the initial position. Alternatively, the control circuit 22 may control the illuminator 16 not to emit light after a certain time period (e.g., 10 seconds) has elapsed since the second manual operating device 9 was moved to the initial position.

In the present embodiment, the state of "emitting light", "light-on", "be lit", “turned on", "lighting" and the like may include emitting a flickering light within a range in which the user visually perceives the light as being continuously lit. Even if the illuminator 16 emits the flickering light, when the frequency is, for example, 100 Hz or higher, the human eye perceives the light as being continuously lit due to the so-called afterimage effect. The light that flickers at such a high frequency may also be regarded as being in the "emitting light" and "light-on" state. In the present embodiment, (i) turning on the illuminator 16 means controlling the illuminator 16 such that the illuminator 16 emits light and (ii) turning off the illuminator 16 means controlling the illuminator 16 such that the illuminator 16 does not emit light.

The control circuit 22 may switch the operation mode of the illuminator 16 during a switchable period. The switchable period in the present embodiment starts from the activation of the control circuit 22 (i.e., when the battery 100 is attached) and ends after a first time period has elapsed. The first time period may be determined as desired. The first time period may be, for example, 10 seconds.

However, in the present embodiment, if the second manual operating device 9 is moved to the ON position during the switchable period, the control circuit 22 disables the first manual operation performed after the second manual operating device 9 is moved to the ON position (hereinafter referred to as an "ON timing"). That is, after the ON timing, the control circuit 22 does not switch the operation mode even if the first manual operation is performed. Therefore, in the present embodiment, moving the second manual operating device 9 from the initial position to the ON position disables the switching of the operation mode even if the first time period has not yet elapsed since the battery 100 was attached. Thus, if the second manual operating device 9 is moved to the ON position before the first time period has elapsed since the control circuit 22 was activated, the switchable period ends at the ON timing.

If the switchable period ends (i.e., the first time period elapses) without the second manual operating device 9 being moved to the ON position (i.e., while remaining in the initial position) after the control circuit 22 is activated, the control circuit 22 disables the first manual operation performed after the switchable period ends. Thus, in the present embodiment, as merely one example, the operation mode can only be switched during the period between the attachment of the battery 100 and the expiration of the first time period.

Therefore, in order to switch the operation mode after the expiration of the switchable period, the battery 100 must be temporarily detached and subsequently reattached. That is, the supply of the power supply voltage Vc to the control circuit 22 is required to be stopped to deactivate the control circuit 22, and then the power supply voltage Vc is required to be supplied again to the control circuit 22 to activate the control circuit 22.

The switching of the operation mode may be performed by any method. In the present embodiment, the operation mode is switched using the first manual operating device 8. Specifically, the operation mode is switched based on the first manual operation being performed on the first manual operating device 8 during the switchable period. For example, when the operation mode is set to the light-on mode and the first manual operation is performed, the control circuit 22 sets (switches) the operation mode to the light-off mode. Conversely, when the operation mode is set to the light-off mode and the first manual operation is performed, the control circuit 22 sets (switches) the operation mode to the light-on mode.

The first manual operation may include any operation. The first manual operation in the present embodiment includes a first specific operation and a second specific operation. The control circuit 22 switches the operation mode when either the first specific operation or the second specific operation is performed during the switchable period.

The first specific operation includes rotating the first manual operating device 8 first from a first position to a second position, and subsequently rotating the first manual operating device 8 from the second position to the first position.

In the present embodiment, the first position is the position where the speed setting value "1" is aligned with the reference position, and the second position is the position where the speed setting value "5" is aligned with the reference position. That is, the first specific operation includes changing the specified setting value from "1" to "5", followed by changing the specified setting value from "5" to "1".

The second specific operation is the reverse of the first specific operation. That is, the second specific operation includes rotating the first manual operating device 8 first from the second position to the first position, and subsequently rotating the first manual operating device 8 from the first position to the second position. That is, the second specific operation includes changing the specified setting value from "5" to "1", followed by changing the specified setting value from "1" to "5".

Thus, the first manual operation of the present embodiment includes changing the specified setting value from the minimum to the maximum and then back to the minimum (i.e., the first specific operation), and performing the reverse operation (i.e., the second specific operation).

However, the first manual operation may include only one of the first specific operation or the second specific operation. Furthermore, the control circuit 22 may be configured to detect that the first manual operating device 8 is positioned at a first end and a second end within its rotatable range. In this case, the first specific operation may be reciprocating movement of the first manual operating device 8 from the first end of the rotatable range, through the second end, to the first end. The second specific operation may be reciprocating movement of the first manual operating device 8 from the second end of the rotatable range, through the first end, to the second end.

When the control circuit 22 switches the operation mode based on the first manual operation, the control circuit 22 causes the illuminator 16 to operate according to a pattern corresponding to the switched operation mode.

Specifically, when the operation mode is switched from the light-off mode to the light-on mode, the control circuit 22 activates (i.e., turns on) the illuminator 16 according to a first lighting pattern. In this case, the user can recognize that the operation mode has been switched to the light-on mode by observing that the illuminator 16 is operating according to the first lighting pattern.

In the present embodiment, the first lighting pattern includes causing the illuminator 16 to remain turned on until a specified turn-off timing, and then turning it off when the specified turn-off timing is reached. The specified turn-off timing may be determined in any manner. In the present embodiment, the specified turn-off timing is the end of the switchable period. However, the specified turn-off timing may also be defined as a time point when the certain time period (e.g., 10 seconds) has elapsed since the operation mode was switched to the light-on mode (i.e., since the first manual operation was performed).

When the operation mode is switched from the light-on mode to the light-off mode, the control circuit 22 turns off the illuminator 16. However, in this case, the control circuit 22 may cause the illuminator 16 to operate according to a second lighting pattern. The second lighting pattern is distinct from the first lighting pattern. The user can recognize that the operation mode has been switched to the light-off mode by observing that the illuminator 16 has been turned off or by observing that the illuminator 16 is operating according to the second lighting pattern.

When the control circuit 22 is activated and sets the operation mode to the light-on mode according to the operation mode stored in the memory 22b, the control circuit 22 turns on the illuminator 16 for a second time period and turns off (i.e., extinguishes) the illuminator 16 after the expiration of the second time period. This allows the user to know the currently set operation mode by attaching the battery 100. The second time period may be determined in any manner. The second time period may be, for example, 10 seconds. That is, the second time period may be the same as the first time period described above.

When an anomaly of the grinder 1 is detected while the motor 30 is driven (i.e., while the second manual operating device 9 is in the ON position), the control circuit 22 turns on the illuminator 16 according to a third lighting pattern. The anomaly of the grinder 1 includes the aforementioned high-temperature error state being set.

In the present embodiment, the third lighting pattern includes causing the illuminator 16 to blink. When an anomaly of the grinder 1 is detected, the control circuit 22 causes the illuminator 16 to blink regardless of whether the operation mode is set to the light-on mode or the light-off mode. As used herein, the term "blink" refers to a state in which the illuminator 16 is intermittently turned on and off at a frequency that allows the user to clearly recognize the repetition of turning on and off. The blinking frequency may be set arbitrarily. In the present embodiment, the frequency of blinking is, for example, 1Hz.

When the grinder 1 is set to the high-temperature error state while the motor 30 is driven, the illuminator 16 begins blinking. Subsequently, in response to the high-temperature error state being cleared while the second manual operating device 9 is maintained in the ON position, the control circuit 22 controls (i.e., activates or deactivates) the illuminator 16 according to the currently set operation mode and drives the motor 30.

After the illuminator 16 begins blinking based on the setting for the high-temperature error state, if the second manual operating device 9 is returned to its initial position while the high-temperature error state is maintained, the control circuit 22 continues to cause the illuminator 16 to blink for an additional, third time period. The third time period may be determined arbitrarily. The third time period may be, for example, 60 seconds.

### 2-4. Main Process

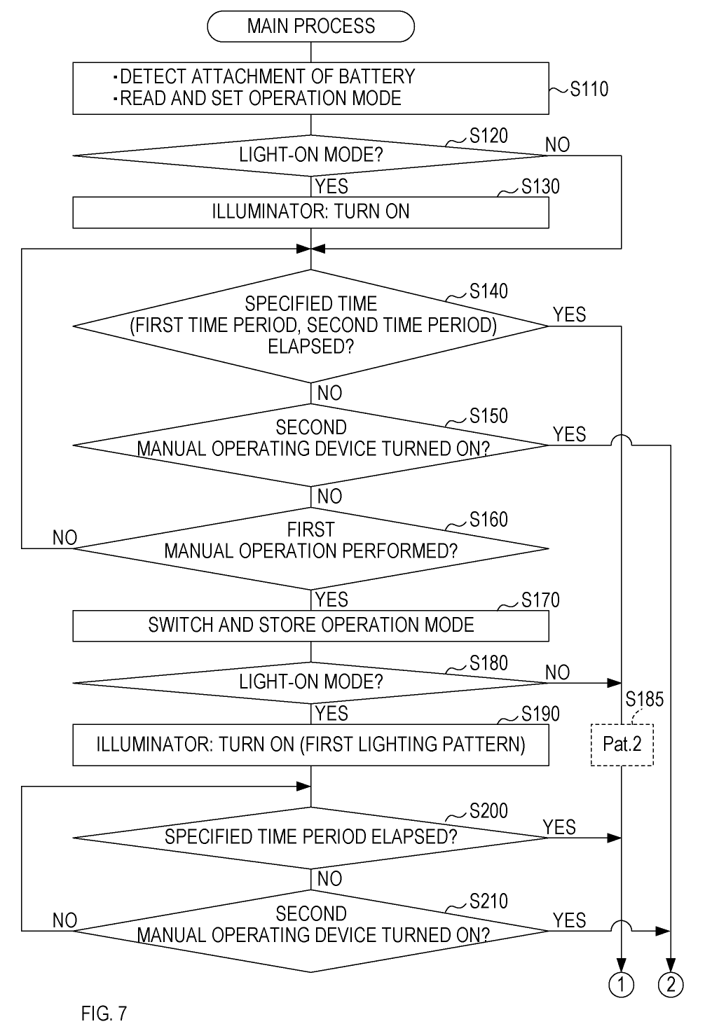

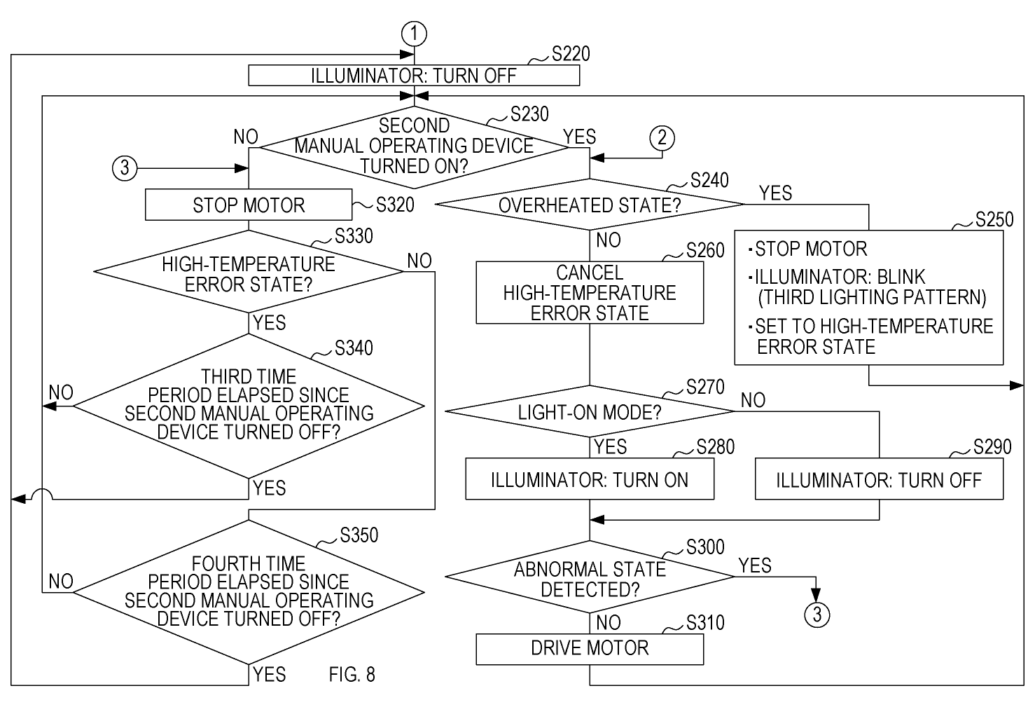

The main process executed by the control circuit 22 (more specifically, CPU 22a) to achieve the various functions described above is explained with reference to FIGS. 7 and 8. Upon activation, the control circuit 22 executes the main process.

Upon starting the main process, the control circuit 22 detects at S110 that the battery 100 is attached and begins measuring a startup elapsed time (or time after activation). The startup elapsed time refers to the elapsed time since the activation of the control circuit 22. The startup elapsed time may be regarded as the elapsed time since detection of the attachment of the battery 100, or in other words, the elapsed time since the battery 100 was attached to the battery port 4a.

In S110, the control circuit 22 further reads the operation mode of the illuminator 16 stored in the memory 22b and sets the operation mode of the illuminator 16 to the read operation mode. For example, when the light-on mode is stored in the memory 22b, the control circuit 22 sets the operation mode to the light-on mode.

In S120, the control circuit 22 determines whether the operation mode is set to the light-on mode. If the operation mode is set to the light-on mode, the process proceeds to S130. In S130, the control circuit 22 turns on the illuminator 16. After the processing in S130, the control circuit 22 proceeds to S140.

If the operation mode is set to the light-off mode in S120, the process proceeds to S140. That is, in this case, the illuminator 16 is not turned on, and the off state is maintained.

In S140, the control circuit 22 determines whether a specified time has elapsed since the activation of the control circuit 22. Specifically, the control circuit 22 determines whether the startup elapsed time that the control circuit 22 is currently measuring has reached the specified time period. The startup elapsed time reaching the specified time period corresponds to the specified time period having elapsed since the activation of the control circuit 22.

The specified time period corresponds to both the aforementioned first and second time periods, each of which is 10 seconds in the present embodiment. That is, in the present embodiment, each of the first time period and the second time period is, for example, 10 seconds. Therefore, in the present embodiment, the processing in S140 includes determining whether the first time has elapsed since the activation of the control circuit 22 and determining whether the second time has elapsed since the activation of the control circuit 22.

If the specified time period has elapsed since the activation of the control circuit 22 in S140, the process proceeds to S220 (see FIG. 8). If the specified time period has not yet elapsed since the activation of the control circuit 22 in S140, the process proceeds to S150.

In S150, the control circuit 22 determines whether the second manual operating device 9 is in the ON position. If the second manual operating device 9 is in the ON position, the process proceeds to S240 (see FIG. 8). If the second manual operating device 9 is not in the ON position (i.e., is in the initial position, for example), the process proceeds to S160.

In S160, the control circuit 22 determines whether the first manual operation has been performed on the first manual operating device 8. That is, the control circuit 22 determines whether an operation for switching the operation mode has been performed. If the first manual operation has not been performed, the process proceeds to S140. If the first manual operation has been performed, the process proceeds to S170.

In S170, the control circuit 22 switches the setting of the operation mode of the illuminator 16. If the current operation mode is set to the light-off mode, the control circuit 22 switches the operation mode to the light-on mode. Conversely, if the current operation mode is set to the light-on mode, the control circuit 22 switches the operation mode to the light-off mode. In S170, the control circuit 22 further stores the switched operation mode in the memory 22b.

In S180, the control circuit 22 determines whether the currently set operation mode (i.e., the operation mode after switching in S170) is the light-on mode. If the current operation mode is the light-off mode, this process proceeds to S220. In S220, the control circuit 22 turns off the illuminator 16. In another embodiment, if the current operation mode is the light-off mode in S180, the process may proceed to S185. In S185, the control circuit 22 turns on the illuminator 16 according to the aforementioned second lighting pattern. After the processing in S185, the process proceeds to S220.

If the current operation mode is the light-on mode in S180, the process proceeds to S190.

In S190, the control circuit 22 turns on the illuminator 16. In this case, the illuminator 16 is turned off after the specified time period has elapsed since the activation of the control circuit 22 (see S200 to S220). Therefore, the control of the illuminator 16 starting from S190 corresponds to turning on the illuminator 16 according to the aforementioned first lighting pattern.

In S200, the control circuit 22 determines whether the specified time period has elapsed since the activation of the control circuit 22 in the same manner as in S140. If the specified time period has elapsed since the activation of the control circuit 22, the process proceeds to S220. If the specified time period has not yet elapsed since the activation of the control circuit 22, the process proceeds to S210.

In S210, the control circuit 22 determines whether the second manual operating device 9 is in the ON position, similarly to S150. If the second manual operating device 9 is not in the ON position, the process proceeds to S200. If the second manual operating device 9 is in the ON position, the process proceeds to S230.

In S220, the control circuit 22 turns off the illuminator 16.

In S230, the control circuit 22 determines whether the second manual operating device 9 is in the ON position, similarly to S150. If the second manual operating device 9 is in the ON position, the process proceeds to S240.

In S240, the control circuit 22 determines whether an overheated state of the grinder 1 has been detected. Specifically, the control circuit 22 determines whether the aforementioned motor overheated state and/or circuit overheated state has been detected. If the motor overheated state and/or circuit overheated state has not been detected, the process proceeds to S260.

In S260, the control circuit 22 cancels the setting of the high-temperature error state.

In S270, the control circuit 22 determines whether the currently set operation mode is the light-on mode. If the current operation mode is the light-on mode, the process proceeds to S280. In S280, the control circuit 22 turns on the illuminator 16.

If the current operation mode is the light-off mode in S270, the process proceeds to S290. In S290, the control circuit 22 turns off the illuminator 16.

In S300, the control circuit 22 determines whether an abnormal state of the grinder 1 has been detected. As mentioned above, the abnormal state includes the overcurrent state. If the abnormal state is detected, the process proceeds to S320. In S320, the control circuit 22 stops the motor 30. If the motor 30 is already stopped, the control circuit 22 maintains that state. That is, if the abnormal state is detected in S300, the control circuit 22 does not drive the motor 30 even if the second manual operating device 9 is in the ON position.

If the abnormal state is not detected in S300, the process proceeds to S310.

In S310, the control circuit 22 drives the motor 30. Specifically, the control circuit 22 executes the aforementioned speed feedback control. After the processing in S310, the process proceeds to S230. However, the driving of the motor 30 is continued. In other words, the processing in S310 is for starting the driving of the motor 30 when the motor 30 is stopped, and for continuing the driving of the motor 30 when the motor 30 is already being driven.

If the motor overheated state and/or circuit overheated state has been detected in S240, the process proceeds to S250.

In S250, the control circuit 22 stops the motor 30. The control circuit 22 further turns on the illuminator 16 according to the third lighting pattern. In the present embodiment, as described above, the third lighting pattern is a blinking pattern. That is, in S250, the control circuit 22 causes the illuminator 16 to start blinking. The control circuit 22 further sets the grinder 1 to the high-temperature error state. Being set to the high-temperature error state means an overheated condition has been detected. After the processing in S250, the process proceeds to S230.

If the second manual operating device 9 is not in the ON position in S230, the process proceeds to S320. In S320, the control circuit 22 stops the motor 30.

In S330, the control circuit 22 determines whether the grinder 1 is set to the high-temperature error state. If the grinder 1 is set to the high-temperature error state, the process proceeds to S340.

In S340, the control circuit 22 determines whether the third time period has elapsed since the second manual operating device 9 was turned off. The third time period is, for example, 60 seconds as described above. Turning off the second manual operating device 9 means that the second manual operating device 9 is not in the ON position. If the third time period has not yet elapsed since the second manual operating device 9 was turned off, the process proceeds to S230.

Therefore, after the illuminator 16 starts blinking in S250, if the second manual operating device 9 is turned off (S230: NO) while the overheated state is maintained (S240: YES), the illuminator 16 continues to blink until it is determined that the third time period has elapsed in S340 (i.e., until a period of 60 seconds has elapsed since the second manual operating device 9 was turned off).

If the third time period has elapsed since the second manual operating device 9 was turned off in S340, the process proceeds to S220. If the process proceeds to S220 while the illuminator 16 is blinking, the illuminator 16 is turned off in S220.

If the grinder 1 is not set to the high-temperature error state in S330, the process proceeds to S350.

In S350, the control circuit 22 determines whether a fourth time period has elapsed since the second manual operating device 9 was turned off. The fourth time period may be set appropriately, and in the present embodiment, the fourth time period is, for example, 10 seconds. If the fourth time period has not yet elapsed since the second manual operating device 9 was turned off, the process proceeds to S230. If the fourth time period has elapsed since the second manual operating device 9 was turned off, the process proceeds to S220. Therefore, for example, if the illuminator 16 is turned on in S280 and the motor 30 starts rotating in S310 and then the second manual operating device 9 is turned off (S230: NO), the illuminator 16 is not turned off immediately. In this case, the illuminator 16 is turned off after the fourth time period has elapsed since the second manual operating device 9 was turned off (S350: YES). The control circuit 22 may temporarily terminate the main process after a specified time period (e.g., 60 seconds) has elapsed since the second manual operating device 9 was turned off. In this case, the control circuit 22 may detect the abnormal state and monitor the state of the second manual operating device 9 using a process other than the main process. Then, for example, when the second manual operating device 9 is turned on, the main process may resume, for example, from S230.

### 3.Other Embodiments

One embodiment of the present disclosure has been described; however, the present disclosure may be embodied in various forms without being limited to the aforementioned embodiment.

3-1. The first manual operating device 8 and the second manual operating device 9 may each be embodied in a form distinct from that of the above embodiment. For example, the first manual operating device 8 may be a rotary body having a form distinct from that of the above embodiment, or may have a form distinct from the rotary body (e.g., a lever, a slider, or the like, as described above). Similarly, the second manual operating device 9 may also be a slider having a form distinct from that of the above embodiment, or may have a form distinct from the slider. Specifically, the second manual operating device 9 may be, for example, in the form of a trigger, a paddle, or the like, as described above.

3-2. The grinder 1 may include a chuck having a form distinct from the collet chuck 13. For example, the grinder 1 may include a chuck in the form of a drill chuck, a scroll chuck, a cam lock chuck, an independent chuck, or an electromagnetic chuck.

3-3. In the above embodiment, two or more speed setting values are indicated in descending order along the first rotational direction D1 on the first manual operating device 8. However, the two or more speed setting values may also be indicated in ascending order along the first rotational direction D1.

3-4. Two or more functions of one element of the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations of the aforementioned embodiments may be omitted. At least a part of the configurations of the aforementioned embodiments may be added to or replaced by another configuration of the aforementioned embodiments.

What is claimed is:

1. A handheld grinder comprising:
a housing (i) extending along a first direction and (ii) including an outer surface and a grip, the grip being configured to be gripped by a user of the handheld grinder;
a power port (i) arranged on the outer surface of the housing and (ii) configured to receive an electric power from a power source;
a motor (i) housed in the housing and spaced apart from the power port in the first direction and (ii) configured to be driven by the electric power received by the power port;
a chuck configured to detachably attach a machining tool, the machining tool (i) being configured to grind and/or polish a workpiece, the machining tool (ii) including a support shaft having a rod shape, the chuck being (i) spaced apart from the motor in the first direction, (ii) configured to detachably attach the support shaft of the machining tool, and (iii) configured to be rotated by the motor;
an illuminator configured to emit light onto the machining tool and/or the workpiece in contact with the machining tool;
a first manual operating device (i) arranged in a region of the housing between the motor and the power port along the first direction and (ii) configured to receive a first manual operation, the first manual operation being performed to selectively set an operation mode of the illuminator to either a light-on mode or a light-off mode; and
a control circuit configured to (i) set the operation mode to the light-on mode or the light-off mode in response to the first manual operation, (ii) control the illuminator not to emit the light based on the operation mode being set to the light-off mode, and (iii) control the illuminator to emit the light based on the operation mode being set to the light-on mode.

2. The handheld grinder according to claim 1, wherein
the first manual operating device is configured to receive a second manual operation different from the first manual operation,
the control circuit is configured to perform a specified function based on the second manual operation being performed on the first manual operating device, and
the specified function is different from setting the operation mode.

3. The handheld grinder according to claim 2, wherein
the specified function includes setting a desired rotational speed for the motor in response to the second manual operation, and
the control circuit is configured to control the motor such that the motor rotates at the desired rotational speed that has been set.

4. The handheld grinder according to claim 1, wherein
the first manual operating device is configured to be manually rotated.

5. The handheld grinder according to claim 4, wherein
the first manual operation includes:
rotating the first manual operating device by a specified amount of rotation or more, and
subsequently reversely rotating the first manual operating device by the specified amount of rotation or more.

6. The handheld grinder according to claim 3, wherein
the first manual operating device is configured to be manually rotated,
the first manual operating device includes two or more speed setting positions (i) that are arranged to be spaced apart from each other along a rotational direction of the first manual operating device and (ii) that respectively correspond to two or more desired rotational speeds different from each other in ascending order or descending order along the rotational direction,
the second manual operation includes aligning any one speed setting position of the two or more speed setting positions with a reference position, and
the control circuit is configured to control a rotation of the motor such that the motor rotates at one desired rotational speed of the two or more desired rotational speeds, the one desired rotational speed corresponding to the one speed setting position aligned with the reference position.

7. The handheld grinder according to claim 6, wherein
the first manual operation includes:
rotating the first manual operating device from a first position to a second position, and
subsequently rotating the first manual operating device from the second position to the first position,
the first position corresponds to a state in which a minimum speed position is aligned with the reference position, the minimum speed position being one of the two or more speed setting positions corresponding to a lowest desired rotational speed, and
the second position corresponds to a state in which a maximum speed position is aligned with the reference position, the maximum speed position being one of the two or more speed setting positions corresponding to a highest desired rotational speed.

8. The handheld grinder according to claim 6, wherein
the first manual operation includes:
rotating the first manual operating device from a second position to a first position, and
subsequently rotating the first manual operating device from the first position to the second position,
the first position corresponds to a state in which a minimum speed position is aligned with the reference position, the minimum speed position being one of the two or more speed setting positions corresponding to a lowest desired rotational speed, and
the second position corresponds to a state in which a maximum speed position is aligned with the reference position, the maximum speed position being one of the two or more speed setting positions corresponding to a highest desired rotational speed.

9. The handheld grinder according to claim 1, wherein
the control circuit is configured:
to switch the operation mode based on the first manual operating device having received the first manual operation during a period between activation of the control circuit and expiration of a switchable period, and
not to switch the operation mode based on (i) the switchable period has elapsed since the activation of the control circuit and (ii) the first manual operating device having received the first manual operation.

10. The handheld grinder according to claim 9, wherein
the switchable period is from the activation of the control circuit to expiration of a first time period.

11. The handheld grinder according to claim 9, further including a second manual operating device, wherein
the second manual operating device is (i) distinct from the first manual operating device and (ii) configured to receive a third manual operation, the third manual operation instructing the control circuit to drive the motor, and
the switchable period ends based on the second manual operating device having received the third manual operation.

12. The handheld grinder according to claim 1, wherein
the control circuit is configured to control the illuminator to emit the light according to a first lighting pattern based on the operation mode having been switched from the light-off mode to the light-on mode.

13. The handheld grinder according to claim 12, wherein
the control circuit is configured to control the illuminator (i) to emit the light according to a second lighting pattern or (ii) not to emit the light, based on the operation mode having been switched from the light-on mode to the light-off mode, and
the second lighting pattern is different from the first lighting pattern.

14. The handheld grinder according to claim 1, further including a memory, wherein
the control circuit is configured to store the operation mode that has been set, in the memory, based on the operation mode having been set to the light-on mode or the light-off mode in response to the first manual operation.

15. The handheld grinder according to claim 14, wherein
the control circuit is configured to set the operation mode of the illuminator to the operation mode stored in the memory in response to activation of the control circuit.

16. The handheld grinder according to claim 1, wherein
the control circuit is configured:
to detect an anomaly of the handheld grinder, and
to control the illuminator to emit the light according to a third lighting pattern based on the anomaly having been detected.

17. The handheld grinder according to claim 1, wherein
the control circuit is configured:
to control the illuminator to emit the light based on (i) the operation mode being set to the light-on mode and (ii) a lighting requirement having been satisfied or being satisfied; and
to control the illuminator not to emit the light based on (i) the operation mode being set to the light-off mode and (ii) the lighting requirement having been satisfied or being satisfied.

18. The handheld grinder according to claim 17, further including a second manual operating device, wherein
the second manual operating device is (i) distinct from the first manual operating device and (ii) configured to receive a third manual operation, the third manual operation instructs the control circuit to drive the motor, and
the lighting requirement is satisfied based on the second manual operating device having received the third manual operation.

19. The handheld grinder according to claim 17, wherein
the lighting requirement is satisfied based on an elapsed time since activation of the control circuit not exceeding a second time period.

20. The handheld grinder according to claim 1, wherein
the power source includes a battery, and
the power port includes a battery port configured to detachably attach the battery.

21. The handheld grinder according to claim 20, wherein
the battery port is configured such that the battery is attached based on the battery being moved in a second direction relative to the battery port,
the outer surface of the housing includes a surface region facing toward a third direction, the third direction is opposite to the second direction, and
the first manual operating device is arranged in the surface region.

22. A method for controlling an illuminator for a handheld grinder, the method comprising:
arranging a manual operating device between a motor and a power port of the handheld grinder, the power port being configured to receive an electric power for driving the motor, the motor being configured to drive a chuck, the chuck being configured to detachably attach a machining tool capable of grinding and/or polishing a workpiece, the manual operating device being configured to receive a manual operation, the manual operation being performed to selectively set an operation mode of the illuminator of the handheld grinder to either a light-on mode or a light-off mode, the light-on mode is a mode in which the illuminator emits light onto the machining tool, the light-off mode is a mode in which the illuminator does not emit the light; and
setting the operation mode in response to the manual operation received by the manual operating device.
